(19) United States
(12) Patent Application Publication
(10) Pub. No.: US 2015/0147028 A1
(43) Pub. Date: May 28, 2015

(54) WAVEGUIDE ASSEMBLY

(71) Applicant: Cymtec Limited, Hengoed, Caerphilly Gwent (GB)

(72) Inventors: Nigel Joseph Copner, Ebbw Vale (GB); Ronald Yandle, Merthyr Tydfil (GB)

(21) Appl. No.: 14/399,947

(22) PCT Filed: Apr. 29, 2013
(86) PCT No.: PCT/GB2013/051086

§ 371 Date: Nov. 7, 2014

(30) Foreign Application Priority Data
May 11, 2012 (GB) 1208267.3

(51) Int. Cl. G02B 6/28

(52) U.S. Cl. CPC G02B 6/2804; G02B 6/2817
USPC 385/24

(57) ABSTRACT

A waveguide assembly for guiding radiation along an optical path, the assembly comprising a first guide element, a second guide element and a coupling element for coupling radiation between the first element and the second element, the first element, second element and coupling element comprising a refractive index along the optical path which is greater than a refractive index of a medium surrounding the elements, wherein, the first and second elements are spaced from the coupling element along the optical path, such that the medium extends between the first element and the coupling element and second element and the coupling element, within the optical path and wherein the radiation is arranged to couple between the first and second guide elements by reflecting within the coupling element from an interface between the coupling element and the medium.

The present invention relates to a waveguide assembly and particularly, but not exclusively to a waveguide assembly for a radiation projection system.

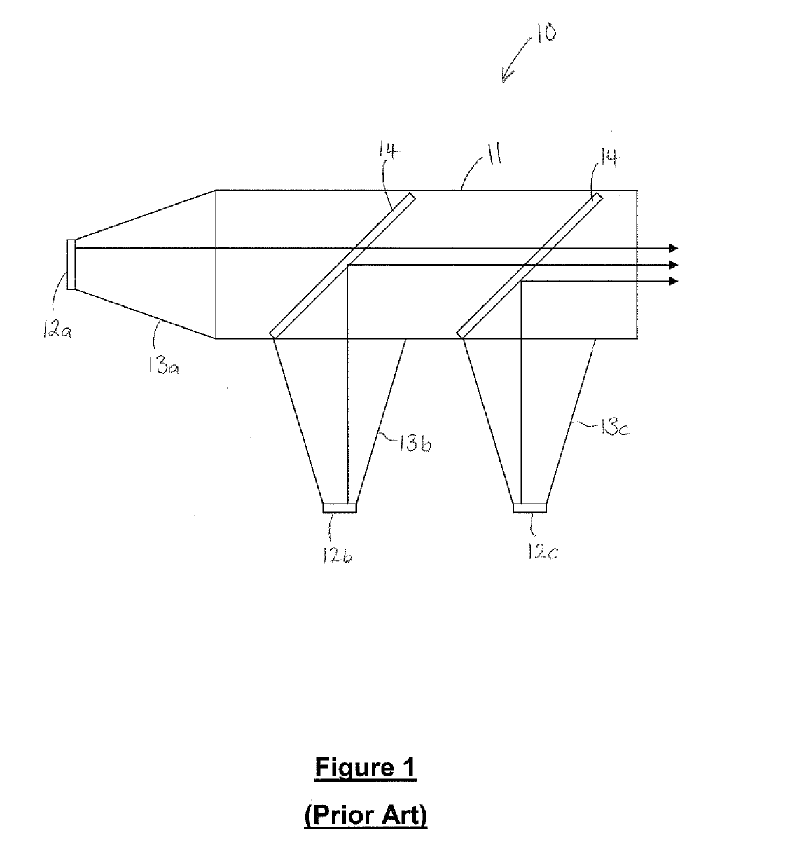

Optical projection systems are known in which red, green and blue light are selectively combined to generate the required optical output. WO2008/147992 discloses a light source assembly 10 in which different wavelengths of radiation are separately launched into a hollow waveguide 11 from a respective source 12a-c, via a respective collimator 13a-c. Upon entering the waveguide 11, the wavelengths are arranged to combine, by reflecting radiation from two sources 12b, 12c off a dichroic mirror 14, along the waveguide 11 to combine with the radiation from the third source 12a which is arranged to direct radiation substantially directly along the waveguide 11, as illustrated in FIG. 1 of the drawings. A problem with such a system 10 however, is that the waveguide 11, collimators 13 and dichroic mirrors 14 separately comprise a number of separate optical elements which must be separately coupled together. This inherently results in a loss of radiation at the coupling points, which thus leads to a reduced optical throughput from the system 10.

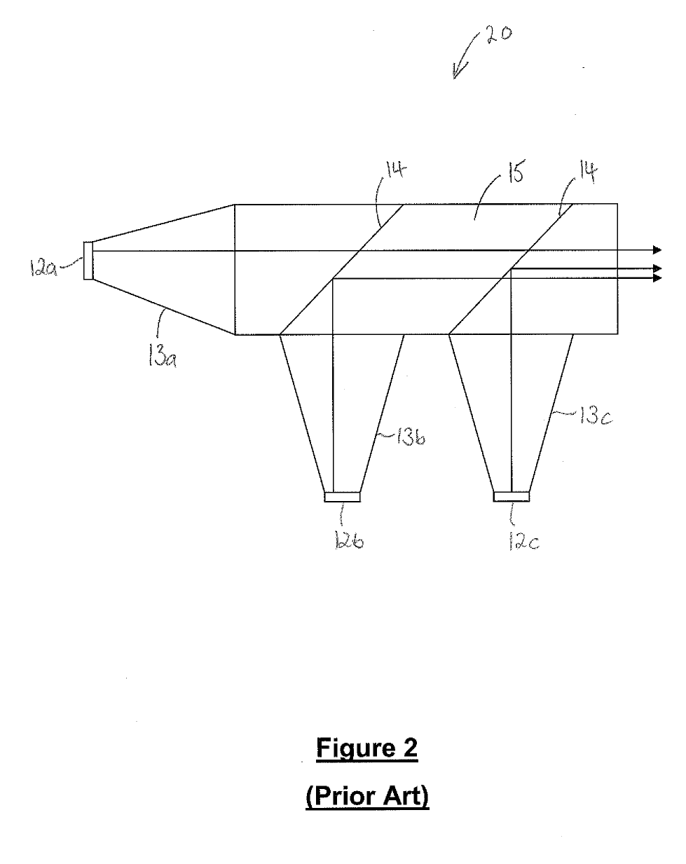

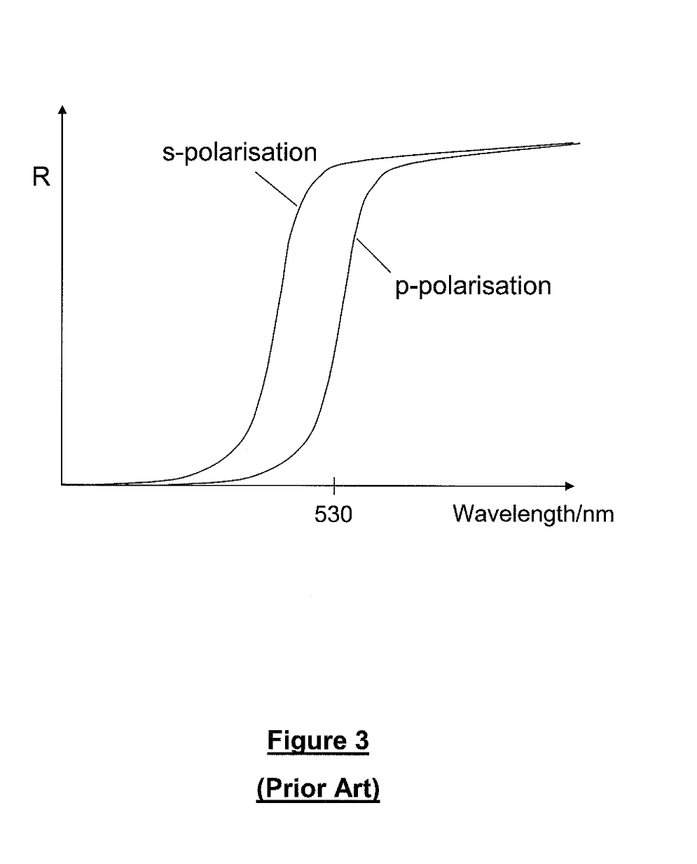

Accordingly, efforts have been made to replace the hollow waveguide 11 with a solid, fused silica waveguide 15 in which the dichroic mirrors 14 are embedded therein, as illustrated in FIG. 2 of the drawings (in which like features have been referenced using the same numerals). However, it is well known from the Fresnel equations which relate reflected and transmitted waves at an interface between two media to the incident wave, that the reflected and transmitted waves are dependent on the polarisation state of the wave. FIG. 3 illustrates the variation in reflection coefficient with wavelength for the p-polarisation state (namely the parallel (p) polarisation state in which the E-field of the incident radiation is directed in the plane of incidence) and the s-polarisation state (namely the transverse (s) polarisation state in which the E-field of the incident radiation is directed out of the plane of incidence) of green light for a particular angle of incidence.

Importantly, it is found that a silica-dichroic-silica interface, namely the interface between the dichroic 14 and the solid waveguide 15 of the system 20 illustrated in FIG. 2, results in a markedly different reflection coefficient for the p- and s-polarisation states of the radiation, with the result that the different polarisation states lead to a broadening of the bandwidth from the respective source. This broadening is particularly pronounced at incident angles of approximately 45° which is typically used in optical projection systems, such as the system illustrated in WO2008/147992, and near the Brewster angle where the reflection of the p-polarisation state reduces to zero. It is evident therefore, that the use of solid waveguides for use in projection systems manifests as a reduction in the optical quality of the radiation output therefrom.

In accordance with the present invention as seen from a first aspect, there is provided a waveguide assembly for guiding radiation along an optical path, the assembly comprising a first guide element, a second guide element and a coupling element for coupling radiation between the first element and the second element,

the first element, second element and coupling element comprising a refractive index along the optical path which is greater than a refractive index of a medium surrounding the guide elements and the coupling element, wherein,

the first and second elements are spaced from the coupling element along the optical path, such that the medium extends between the first element and the coupling element and second element and the coupling element, within the optical path, and wherein

the radiation is arranged to couple between guide elements by reflecting within the coupling element from an interface between the coupling element and the medium.

Advantageously, the increased refractive index of the elements compared with the surrounding medium facilitates the guidance of radiation via total internal reflection. This obviates the requirement to otherwise coat the guide elements with a dichroic material, for example. Moreover, the reflection of the radiation within the coupling element from an interface between the coupling element and the medium, minimises any broadening of the bandwidth of the radiation from the respective sources due to polarisation dependence of reflection, which would otherwise occur in the event that the reflection was made at an interface within the coupling element.

The spacing between the first element and the coupling element, and between the second element and the coupling element is preferably less than 50 μm, more preferably less than 30 μm and most preferably in the range 10-20 μm.

Preferably, the first guide element and the second guide element are arranged to guide radiation in substantially different directions. It is found that the spacing between elements of the assembly further minimises any loss of radiation from the guide elements at the coupling elements where the radiation becomes re-directed, which would otherwise be associated with a continuous waveguide. Accordingly, the separated elements enable the elements of the assembly to be folded to reduce the volume occupied by the assembly.

The assembly conveniently comprises a first radiation source for generating radiation having a first principle wavelength and a second radiation source for generating radiation having a second principle wavelength.

The first element is preferably arranged to receive radiation from the first radiation source and the second element is preferably arranged to receive radiation from the second radiation source. Conveniently, the radiation from the second source is coupled into the second element via the coupling element. The first guide element advantageously comprises a collimator for coupling light from the first source into the first guide element and the coupling element advantageously comprises a collimator for coupling the radiation from the second source into the second guide element.

Preferably, coupling element comprises a facet which is arranged to reflect radiation from the first element along the second element. The facet beneficially comprises a dichroic coating disposed upon an end face of the coupling element, for reflecting radiation having the first principle wavelength.

The radiation from the first and second sources are preferably arranged to combine in the second element.

Advantageously, the assembly further comprises a further coupling element for coupling the radiation between the second guide element and a third guide element. The further coupling element is preferably spaced from the second element and the third element such that the medium extends between the second element and the coupling element and between the third element and the coupling element, within the optical path.

Preferably, the refractive index of the further coupling element and the third coupling element along the optical path is greater that the refractive index of the medium.

The third element is further arranged to receive radiation from a third radiation source which is arranged to generate radiation having a third principle wavelength. The radiation from the third source is conveniently coupled into the third element via the further coupling element. Advantageously the further coupling element comprises a collimator for coupling the radiation from the third source into the third guide element.

The further coupling element comprises a facet which is arranged to reflect radiation from the second element along the third element. The facet beneficially comprises a dichroic coating for reflecting radiation having the first and second principle wavelength. Accordingly, the radiation from the first, second and third sources are arranged to combine in the third guide element.

Preferably, at least the first element, the second element and the coupling element comprise solid elements which are advantageously formed of fused silica. However, it is also desirable for the third element and the further coupling element to comprise a solid element which is similarly formed of fused silica.

In accordance with the present invention as seen from a second aspect, there is provided a radiation projection arrangement for projecting radiation, the arrangement comprising a waveguide assembly according to the first aspect and a lensing arrangement for manipulating the radiation output from the assembly.

Preferred features of the projection arrangement of the second aspect may comprise one or more of the preferred features of the waveguide assembly of the first aspect.

Embodiments of the present invention will now be described by way of example only and with reference to the accompanying drawings, in which:

FIG. 1 is a schematic illustration of a known optical projection system comprising a hollow waveguide;

FIG. 2 is a schematic illustration of an optical projection system comprising a solid waveguide;

FIG. 3 is a graphical representation of the polarisation dependence of reflection of green light at a silica-silica interface;

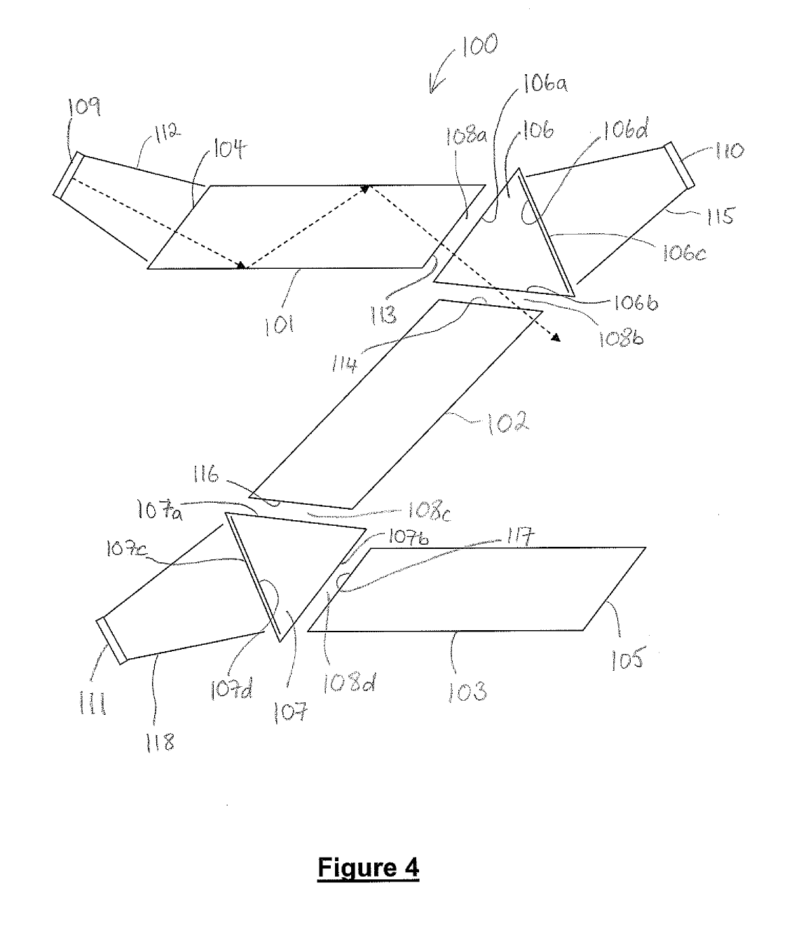

FIG. 4 is a schematic illustration of a waveguide assembly according to an embodiment of the present invention; and

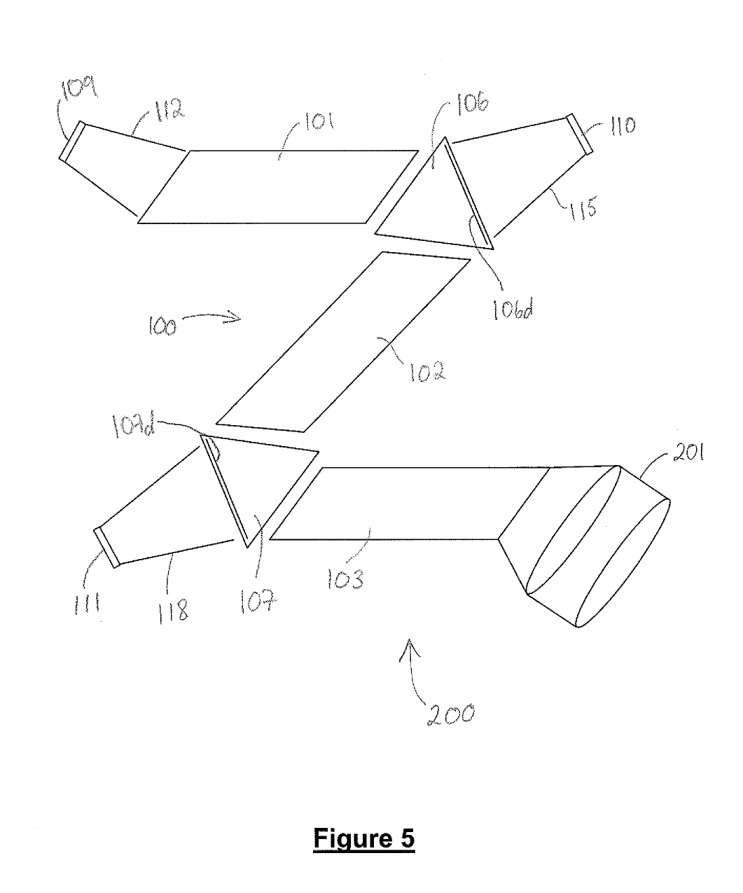

FIG. 5 is a schematic illustration of a radiation projection system according to an embodiment of the present invention.

Referring to FIG. 4 of the drawings, there is illustrated a waveguide assembly 100 according to an embodiment of the present invention. The assembly 100 comprises an optical path defined by a first 101, second 102 and third elongate guide element 103, which may be formed of fused silica, for example. The elements 101, 102, 103 are substantially rectangular in cross-section, however this skilled reader will recognise that other cross-sectional shapes may equally be used, and are substantially solid elements, as distinct from hollow elements. The guide elements 101, 102, 103 are arranged to guide radiation along the optical path from an entrance aperture disposed on a proximal end face 104 of the first guide element 101 to an exit aperture disposed at the distal end face 105 of the third guide element 103. The guide elements 101, 102, 103 are spaced from each other and the radiation is coupled between consecutive guide elements along the optical path by a respective coupling element 106, 107, which may be similarly formed of substantially fused silica. The coupling elements 106, 107 are spaced from the guide elements 101, 102, 103 between which the radiation is to be coupled, such that each element of the assembly 100 is spaced by an air gap 108 of typically 10-50 μm.

The guide elements 101, 102, 103 and coupling elements 106, 107 comprise a refractive index which is greater than the surrounding medium, such as air for example, and are arranged to guide radiation via total internal reflection. The radiation is received into the respective guide element 101, 102, 103 from a respective radiation source 109, 110, 111. In this respect, a first source 109 is arranged to generate radiation having a wavelength of approximately 480 nm, namely blue light and the blue light is coupled into the first guide element 101 through the entrance aperture disposed at the proximal end face 104 thereof, via a collimator 112. The blue light is guided along the first element 101 via total internal reflection to a distal end face 113 thereof which forms an interface with the air gap 108a between the first element 101 and a coupling element 106. The blue light is arranged to strike the distal end face 113 of the first guide element 101 at an angle greater than the critical angle for total internal reflection and is thus arranged to pass out from the first guide element 101 across the air gap 108a into the coupling element 106. The coupling element 106 is substantially wedge shaped and comprises a first face 106a which is arranged to extend substantially parallel to the distal face 113 of the first element 101 and a second face 106b which is arranged to extend substantially parallel to a proximal face 114 of the second guide element 102. A distal face 106c of the coupling element 106, namely the face extending between the first and second faces 106a, 106b of the coupling element 106 is coated with a dichroic 106d which is suited to reflect radiation having a wavelength of substantially 480 nm. In this respect, the coupling element 106 is arranged to couple the blue light into the second guide element 102 which is orientated at substantially 60° to the first guide element 101 by reflecting the blue light within the element 106, from the dichroic 106d which forms an interface with the surrounding air.

The coupling element 106 further comprises a collimator 115 disposed proximate the distal face 106c thereof which extends away from the coupling element 106, and is arranged to couple radiation having a wavelength of approximately 530 nm, namely green light, from a second radiation source 110 into the assembly 100. The green light is directed substantially along an axis comprising an axis of the second guide element 102 and is thus arranged to pass into the coupling element 106 through the distal face 106c and out from the second face 106b thereof, across the air gap 108b, into the second element 102 through the proximal end face 114 of the second element 102.

The second element 102 is thus arranged to guide blue and green light via total internal reflection toward a distal end face 116 thereof. The distal end face 116 of the second guide element 102 forms an interface with a further air gap 108c which extends between the second element 102 and a further coupling element 107. The further coupling element 107 is similarly substantially wedge shaped and comprises a first face 107a which is arranged to extend substantially parallel to the distal end face 116 of the second guide element 102 and a second face 106b which is arranged to extend substantially parallel to a proximal end face 117 of the third guide element 103. A distal face 107c of the further coupling element 107, namely the face 107c extending between the first and second faces 107a, 107b of the further coupling element 107 is coated with a dichroic 107d which is suited to reflect radiation having a wavelength of substantially 480 nm and 530 nm. In this respect, the coupling element 107 is arranged to couple the blue and green light into the third guide element 103 which is orientated at substantially 60° to the second guide element 102, by reflecting the blue and green light within the element 107, from the dichroic 107d which forms an interface with the surrounding air.

The further coupling element 107 further comprises a collimator 118 disposed proximate the distal face 107c thereof which extends away from the further coupling element 107, for coupling radiation having a wavelength of approximately 640 nm, namely red light, from a third radiation source 111 into the assembly 100. The red light is directed substantially along an axis comprising an axis of the third guide element 103 and is thus arranged to pass into the further coupling element 107 through the distal end face 107c and out from the second face 107b thereof, across the air gap 108d into the third element 103 through the proximal end face 117 of the third element 103. The third element 103 is thus arranged to guide blue, green and red light via total internal reflection toward the exit aperture of the assembly 100, which is disposed at the distal end face 105 of the third guide element 103.

The refractive index variation across the dichroic/air interface associated with each coupling element 106, 107 reduces the effect of the polarisation dependence of reflection and thus the wavelength separation of the radiation as the radiation becomes reflected therefrom. Moreover, the air gaps 108 which exist between the guide elements 101, 102, 103 and the coupling elements 106, 107 minimises the propagation of radiation direct from the first element 101 through the coupling element 106 into the second element 102, which would otherwise be associated with a continuous waveguide in which the first and second guide elements 101, 102 are coupled directly to the coupling element. Referring to FIG. 4 for example, the beam indicated with the dashed line would pass directly through the coupling element 106 from the first guide element 101 and become incident upon a side face of the second guide element 102 at an angle greater that the critical angle for total internal reflection, and thus become lost from the assembly, in the event that the first, second and coupling elements 101, 102, 106 were formed integrally or otherwise arranged in direct contact. The air gaps 108 in combination with the coupling elements 106, 107 thus enable the guide elements 101, 102, 103 to be folded upon each other in a serpentine configuration to reduce the volume occupying space of the assembly 100.

Referring to FIG. 5 of the drawings, there is illustrated a radiation projection system 200 comprising a waveguide assembly 100 according to the above described embodiment. The system 200 comprises a lensing arrangement 201 for manipulating the radiation output from the exit aperture of the third guide element 103. The reduced occupied space of the waveguide assembly 100 provides for a more compact projection system 200.

In further embodiments of the present invention, the assembly 100 and projection system 200 may comprise further guide elements (not shown) and coupling elements (not shown) for guiding infra-red radiation and/or ultraviolet radiation, for example. It is envisaged that the infra-red will find suitable applications in night vision projection systems (not shown), whereas the ultra-violet radiation is particularly suited to endoscopy in the treatment of tissue, for example.

From the foregoing therefore, it is evident that the waveguide assembly provides for an improved guidance of radiation and thus an improved optical efficiency in radiation projection systems.

1. A waveguide assembly for guiding radiation along an optical path, the assembly comprising a first guide element, a second guide element and a coupling element for coupling radiation between the first element and the second element,
the first element, second element and coupling element comprising a refractive index along the optical path which is greater than a refractive index of a medium surrounding the elements, wherein,
the first and second elements are spaced from the coupling element along the optical path, such that the medium extends between the first element and the coupling element and second element and the coupling element, within the optical path, and wherein
the radiation is arranged to couple between the first and second guide elements by reflecting within the coupling element from an interface between the coupling element and the medium.

2. An assembly according to claim 1, wherein the spacing between the first element and the coupling element, and between the second element and the coupling element is less than 50 μm.

3. An assembly according to claim 1, wherein the first guide element and the second guide element are arranged to guide radiation in substantially different directions.

4. An assembly according to claim 1, further comprising a first radiation source for generating radiation having a first principle wavelength and a second radiation source for generating radiation having a second principle wavelength.

5. An assembly according to claim 4, wherein the first element is arranged to receive radiation from the first radiation source and the second element is arranged to receive radiation from the second radiation source.

6. An assembly according to claim 4, wherein the radiation from the second source is coupled into the second element via the coupling element.

7. An assembly according to claim 4, wherein the first guide element comprises a collimator for coupling light from the first source into the first guide element.

8. An assembly according to claim 4, wherein the coupling element comprises a collimator for coupling the radiation from the second source into the second guide element.

9. An assembly according to claim 1, wherein the coupling element comprises a facet which is arranged to reflect radiation from the first element along the second element.

10. An assembly according to claim 9, wherein the facet comprises a dichroic coating disposed upon an end face of the coupling element, for reflecting radiation having the first principle wavelength.

11. An assembly according to claim 4, wherein the radiation from the first and second sources is arranged to combine in the second element.

12. An assembly according to claim 1, further comprising a further coupling element for coupling the radiation between the second guide element and a third guide element.

13. An assembly according to claim 12, wherein the further coupling element is spaced from the second element and the third element such that the medium extends between the second element and the coupling element and between the third element and the coupling element, within the optical path.

14. An assembly according to claim 12, wherein the further coupling element and the third guide element comprises a refractive index along the optical path which is greater that the refractive index of the medium.

15. An assembly according to claim 12, wherein the third element is further arranged to receive radiation from a third radiation source which is arranged to generate radiation having a third principle wavelength.

16. An assembly according to claim 15, wherein the radiation from the third source is coupled into the third element via the further coupling element.

17. An assembly according to claim 12, wherein the further coupling element comprises a collimator for coupling the radiation from the third source into the third guide element.

18. An assembly according to claim 12, wherein the further coupling element comprises a facet which is arranged to reflect radiation from the second element along the third element.

19. An assembly according to claim 18, wherein the facet of the further coupling element comprises a dichroic coating disposed upon an end face of the coupling element, for reflecting radiation having the first and second principle wavelength.

20. An assembly according to claim 1, wherein at least the first element, the second element and the coupling element comprise solid elements.

21. An assembly according to claim 1, wherein at least the first element, the second element and the coupling element are formed of fused silica.

22. A radiation projection arrangement for projecting radiation, the arrangement comprising a waveguide assembly according to claim 1 and a lensing arrangement for manipulating the radiation output from the assembly.
